(19) United States
(12) Patent Application Publication
(10) Pub. No.: US 2025/0338193 A1
(43) Pub. Date: Oct. 30, 2025

(54) Broadband Connectivity

(71) Applicant: Vodafone Group Services Limited, Newbury, Berkshire (GB)

(72) Inventors: Martin Steward TURNER, London (GB); James Jonathan BURCH, London (GB)

(21) Appl. No.: 18/866,308

(22) PCT Filed: May 12, 2023
(86) PCT No.: PCT/GB2023/051251

§ 371 Date: Nov. 15, 2024

(30) Foreign Application Priority Data
May 18, 2022 (GB) 2207274.8

(51) Int. Cl. H04W 36/30; H04W 36/00; H04W 88/06

(52) U.S. Cl. CPC H04W 36/30; H04W 36/0069; H04W 88/06

(57) ABSTRACT

System and method for managing a Wi-Fi network, comprising a Wi-Fi client subscribing to a broadband status of a gateway when the Wi-Fi client connects to the access point of the gateway. The Wi-Fi client detecting a change in the subscribed broadband status indicating a disruption in broadband connectivity of the gateway and in response to the detected change of the subscribed broadband status generating a user notification on the Wi-Fi client.

### FIELD OF THE INVENTION

The present invention relates to a system and method for managing a broadband network and in particular, managing the network internet connectivity of clients within a Wi-Fi network.

### BACKGROUND OF THE INVENTION

Internet or broadband connectivity is usually provided in the home or office using a combined Wi-Fi router and modem (e.g., DSL or cable) known as a gateway. One or more client devices may be connected wirelessly to the gateway.

The modem connects to the internet over a DSL or cable network using copper or fibre optic cables. Whilst such internet connections are usually stable for long periods, these internet connections can fail for a number of reasons. For example, the local exchange can experience problems or require maintenance.

Local Wi-Fi clients may display a strong Wi-Fi signal from their connected gateway even if internet access becomes unavailable. It may be that the first indication of a connection problem to a user is when internet access is actually required. This may occur some time after the broadband or internet outage occurred. This can be irritating to a user and can extend the time needed to rectify the problem due to delays in starting remedial action.

Therefore, there is required a method and system that overcomes these problems.

### SUMMARY OF THE INVENTION

Internet or broadband connectivity is usually provided in the home using a combined Wi-Fi router and modem (e.g., DSL or cable) known as a gateway. One or more client devices may be connected wirelessly to the gateway. When a wireless device (e.g., a smart phone or tablet computer) makes a wireless connection with the gateway, the client subscribes to or registers with a particular service within the gateway. For example, this subscription may be achieved using universal plug and play (UPnP) general event notification architecture (GENA). Other subscription services may be used.

This particular service relates to the broadband connection or connectivity status of the gateway (e.g., through a fixed line interface such as a modem). For example, when internet access of the DSL or cable becomes unstable, has a significant reduction in broadband download and/or upload speed (e.g., less than 10-50% of its maximum), or ceases entirely, then the subscription service can broadcast an update to subscribed clients indicating such an occurrence.

The Wi-Fi client or clients will then provide a notification to their users in response to this detected change. A user may or may not be using their device when the broadband status change (i.e., deterioration) occurs. They may be using the device but not accessing the internet at the time and so may be unaware of the broadband connection issue. Other devices in the home may require internet connectivity using the gateway at the same time. For example, a home data storage system may cease to be connected to the internet or a home security system may become disconnected from an alarm monitoring service and this may be unnoticed by the home occupants for some time. Therefore, this early and immediate notification can provide a faster resolution of the problem before further problems arise. Furthermore, it can be inconvenient or irritating to the home occupants to only discover the broadband connection issue when they require internet connectivity (e.g., when they wish to join a video conference call). The present system and method instead notifies the user as soon as one or more broadband connection problems arise. The gateway may also be described as a router. In any case, the gateway forms a device (or set of more than one device) that includes components to provide LAN (Wi-Fi) connectivity to local clients and includes components to connect to a broadband provider (e.g., over DSL or cable). In this way, the system and method manages the Wi-Fi network.

The client subscribes to the broadband connection or connectivity status of the gateway. Subscription occurs at the time or soon after the wireless device makes the wireless connection to the gateway. Therefore, only clients that have the additional functionality are subscribed to this information service and the gateway does not need to determine which clients need to be informed when broadband becomes unavailable. The gateway does not need to carry out any traffic analysis or request further information from each Wi-Fi client to maintain and update lists of clients that need to be informed, which lowers its processing overheads. For example, most Wi-Fi clients using the gateway may not have an alternative cellular connection and so there would be no need to inform them that the broadband service is interrupted as they couldn't switch to cellular. This improves the efficiency of the system. Furthermore, the device registration and the notification are completely automated, and the user does not have to do anything at all to make use of this functionality.

Against this background and in accordance with a first aspect there is provided a method for managing a Wi-Fi network, the method comprising the steps of:
a Wi-Fi client subscribing to a broadband status of a gateway when the Wi-Fi client connects to the access point of the gateway;
the Wi-Fi client detecting a change in the subscribed broadband status indicating a disruption in broadband connectivity of the gateway; and
in response to the detected change of the subscribed broadband status generating a user notification on the Wi-Fi client. Managing the Wi-Fi network may involve passive monitoring and alerts or may result in active measures, such as restoring connectivity after network outages. The Wi-Fi client may be any device (portable or static) that has Wi-Fi network capabilities. These include smartphones, tablet computers, desktop computers and laptop computers, for example.

Optionally, the Wi-Fi client may subscribe to the broadband status using universal plug and play, UPnP, general event notification architecture, GENA. Other subscription protocols may be used.

Optionally, the method may further comprise the step of the Wi-Fi client passing the detected changed broadband status to an application of the Wi-Fi client. For example, the application may be running in the background and detect the broadband status change. There may be several different broadband statuses and any one or more may trigger the application to carry out particular actions. These published statuses may include indications that the gateway no longer has any connectivity to the internet, the connection is unstable, or the connection falls at or below a performance threshold (e.g., upload speed, download speed, latency, error rate, etc.). Passing the status to the application may be done directly or may comprise the generation of a trigger, prompt or other message indicating that a particular broadband status or one of a set of broadband statuses has occurred.

Preferably, the method may further comprise the step of the application disconnecting the Wi-Fi client from the Wi-Fi network. As the Wi-Fi connection no longer provide internet or external network access then it can prevent network connectivity to the client. Therefore, disconnection of Wi-Fi (e.g., by disabling Wi-Fi functionality on the client) can prompt the client to attempt alternative connections. This may include activating a cellular data connection, in the case of a client with cellular capability.

Advantageously, the method may further comprise the step of the Wi-Fi client connecting to a cellular data network. At this point the Wi-Fi client may become a cellular client (with a disabled or non-functioning Wi-Fi connection). There may be other ways in which internet connectivity is provided whether or not the Wi-Fi connection remains active.

Optionally, the method may further comprise the step of the application:
logging on to an external server using user credentials of a user of the Wi-Fi client (e.g., using their internet service provider (ISP) account credentials), wherein the external server includes broadband connectivity reinstatement functionality. Therefore, the application provides a convenient or easier way to attempt to restore internet connectivity with the gateway and any connected clients. Upon successful restoration of an internet connection to the gateway, the Wi-Fi client can reinstate a Wi-Fi connection to the gateway and use that reconnection to access the internet instead of using the cellular network.

Optionally, the external server may be accessed by the application of the Wi-Fi client using the cellular data network. Therefore, resolution of the cause of broadband outage or disruption can be made.

Optionally, the method may further comprise the step of the application:
presenting a user of the Wi-Fi client with a shortcut or hyperlink to an external server requesting assistance with broadband connectivity. The external server may be part of an ISP that provides the gateway with broadband connectivity. The application may use pre-generated or stored shortcuts or hyperlinks or may generate them immediately before use. The shortcuts or hyperlinks may also include user details or user credentials so that any logon or validation fields in the resulting webpage can be pre-populated as much as possible and link to the user's ISP account, for example. The shortcut or hyperlink may be automatically launched or may be presented to a user for manual selection and launch.

Optionally, the user notification may be delayed by a predetermined time from the detection of the change of the subscribed broadband status. This allows temporary or short-lived outages to be resolved without unnecessary notifications. The user notification may also be supressed at certain times of day (e.g., at night), for example.

Preferably, the predetermined time or times of day may be user-configurable using an application of the Wi-Fi client. The predetermined time may also be fixed or static.

Optionally, the change in the broadband status may be any one or more of a total loss of broadband connectivity between the gateway and the internet or a reduction in broadband speed below a predetermined threshold. Other status types may be used.

According to a second aspect, there is provided a data processing apparatus or system comprising means for carrying out the method according to any previous claim.

According to a third aspect, there is provided a system comprising:
a gateway having an access point and a broadband interface, the gateway configured to provide a subscription to a broadband status of the gateway;
one or more Wi-Fi clients, the Wi-Fi clients configured to:
   subscribe to the broadband status of the gateway when the Wi-Fi client connects to the access point of the gateway,
   detect a change in the broadband status indicating a disruption in broadband connectivity of the gateway, and
   in response to the detected change of the subscribed broadband status generating a user notification on the Wi-Fi client. The broadband interface may include any one or more of DSL, cable and cellular interface (e.g., fixed line or wireless).

Optionally, the gateway may be configured to provide broadband connectivity using a digital subscriber line, DSL. A cable provider may also be used.

Optionally, the system may further comprise an external server configured to:
validate credentials of the Wi-Fi client, and
reinstate broadband connectivity of the gateway upon request from the Wi-Fi client.

Should the client lose the subscription to the broadband status service then this can be restored automatically by the application. If the Wi-Fi client re-acquires the Wi-Fi connection (e.g., when a user returns home with their smartphone) then the broadband status service can be re-subscribed as part of the Wi-Fi connection method with the gateway so that any future outage can be detected and notified and/or resolved.

In accordance with a further aspect, there is provided an application configured to detect a change to a broadband status of a gateway, as published as a subscription service by a gateway providing Wi-Fi connectivity to a client device running the application;
the application detecting a change in the subscribed broadband status indicating a disruption in broadband connectivity of the gateway; and
in response to the detected change of the subscribed broadband status switching internet connectivity of the client device from Wi-Fi to cellular.

The application may also be configured to wait a predetermined time before switching. The application may carry out the switch by disabling Wi-Fi functionality of the client device, which in response initiates a new internet connection using a cellular interface. The application may carry out any or all of the functions or steps described above.

The methods described above may be implemented as a computer program comprising program instructions to operate a computer. The computer program may be stored on a computer-readable medium.

The computer system may include a processor or processors (e.g. local, virtual or cloud-based) such as a Central Processing unit (CPU), and/or a single or a collection of Graphics Processing Units (GPUs). The processor may execute logic in the form of a software program. The computer system may include a memory including volatile and non-volatile storage medium. A computer-readable medium may be included to store the logic or program instructions. The different parts of the system may be connected using a network (e.g. wireless networks and wired networks). The computer system may include one or more interfaces. The computer system may contain a suitable operating system such as iOS, Android (RTM), UNIX, Windows (RTM) or Linux, for example.

It should be noted that any feature described above may be used with any particular aspect or embodiment of the invention.

### BRIEF DESCRIPTION OF THE FIGURES

The present invention may be put into practice in a number of ways and embodiments will now be described by way of example only and with reference to the accompanying drawings, in which:

FIG. 1 shows a schematic diagram of a system for managing a network including a client, given by way of example only;

FIG. 2 shows a flowchart of a method for managing the network of FIG. 1;

FIG. 3 shows a flowchart of further steps of the method for managing the network of FIG. 1; and

FIG. 4 shows screen shots from the client of FIG. 1.

It should be noted that the figures are illustrated for simplicity and are not necessarily drawn to scale. Like features are provided with the same reference numerals.

### DETAILED DESCRIPTION OF THE PREFERRED EMBODIMENTS

This described system and method manages network connectivity and provides automated fixed line diagnostics and notifications. The system provides improved notifications of fixed line faults to a user device. Once notified, the user can take remedial action to restore network connectivity. For example, they can use an internet service provider's (ISP) self-service facilities to diagnose the problem and reach a resolution. The system and method more gracefully handles broadband disconnections.

The system takes advantage of functionality within a router or gateway that monitors its fixed line connection status.

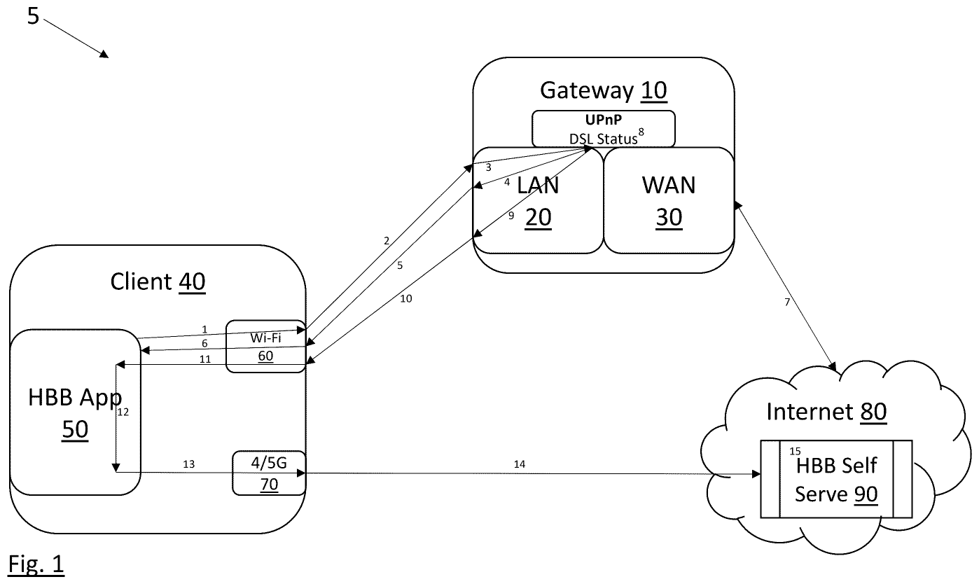

FIG. 1 shows a schematic diagram of a system 5 for managing a wireless or Wi-Fi network. A gateway 10 includes local area network (LAN) functionality provided by a LAN interface 20. This LAN interface 20 broadcasts a SSID enabling Wi-Fi clients to connect to the gateway 10. The LAN interface 20 acts as the access point of the gateway and provides wireless connectivity to one or more client devices. The gateway 10 also includes a wide area network (WAN) interface 30 providing access to the internet (e.g., a broadband interface). For example, the WAN interface 30 may be a digital subscriber line (DSL) interface providing broadband access to the internet 80 over telephone lines. Alternatively, the WAN interface 30 may be provided by a cable network provider.

Client 40 includes two network interfaces. Wi-Fi interface 60 enables local wireless connectivity using the LAN interface 20 of the gateway 10. The client 40 also includes a cellular interface 70 (e.g., 4/5G or LTE). The client 40 may attempt to connect using its Wi-Fi interface 60 with any known wireless networks as they become available in preference to the cellular interface 70.

The client 40 also includes an installed home broadband (HBB) app 50 that can manage aspects of the client's network connections.

The gateway 10 includes universal plug and play (UPnP) functionality. In particular, the UPnP functionality enables clients to subscribe to a broadband status (e.g., DSL status) of the gateway 10.

When the gateway 10 experiences a broadband outage (i.e., the WAN interface 30 cannot access the internet 80) then the broadband status of the gateway 10 changes and this changes broadcast to any subscribing clients.

A home broadband (HBB) self-serve server 90 is located remote to the gateway 10 and client 40. For example, the HBB self-serve server 90 is accessible over the internet 80 and can communicate with the HBB at 50 of the client 40.

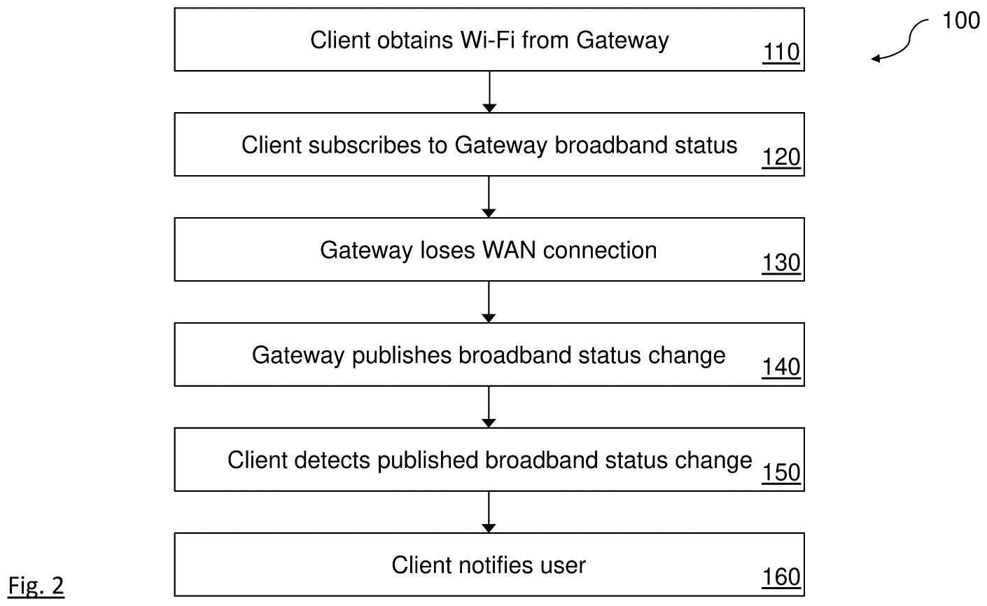

FIG. 2 shows a flowchart of a method 100 for operating the system 5 described with reference to FIG. 1.

At step 110, the client 40 detects the SSID of a Wi-Fi network broadcast using the LAN interface 20 of the gateway 10. The client 40 obtains Wi-Fi connectivity from the gateway 10. If this is the first connection, then this may include providing any necessary key or password of the SSID. If such credentials have been previously stored on the client 40 then these are provided by the client 40 during security negotiations with the gateway 10.

As part of this Wi-Fi connection process between the client 40 and the gateway 10, the client 40 subscribes to the gateway broadband status (e.g. DSL status) of the gateway 10. As previously mentioned, the gateway 10 includes UPnP functionality and this subscription may be obtained via UPnP general event notification architecture (GENA).

As long as the Wi-Fi connection between the client 40 and the gateway 10 remains in effect, any updates to the broadband status being broadcast by the gateway 10 is available to the client 40. Should the WAN broadband connection of the gateway 10 (e.g., connection over DSL) become unavailable or otherwise degraded to a particular level or threshold then the broadband status of gateway 10 may change. For example, at step 130, the gateway 10 may lose broadband connection and this is indicated by the DSL status change of the gateway 10. This broadband status change is published by the gateway 10 at step 140 and the client detects this published status change at step 150. The client 40 provides a notification to a user indicating a problem or issue with broadband connectivity. This may be otherwise unapparent to the user as the Wi-Fi connection between the client 40 and the gateway 10 remains.

In some example implementations, a message, notification or banner may appear on the screen of the client 40, which may be a mobile device such as a smartphone, for example. In other example implementations, the notification may include an icon change and may be visible on the screen of the client 40. Sounds, haptic events or other notifications may be issued.

In any case, the client 40 notifies the user at step 160. Different device types may include different types of user notifications.

Therefore, the user has been made aware of the broadband issue whether or not they are actively accessing the internet at the time that the broadband status changed. In further example implementations, other actions may be triggered in response to this detected broadband status change.

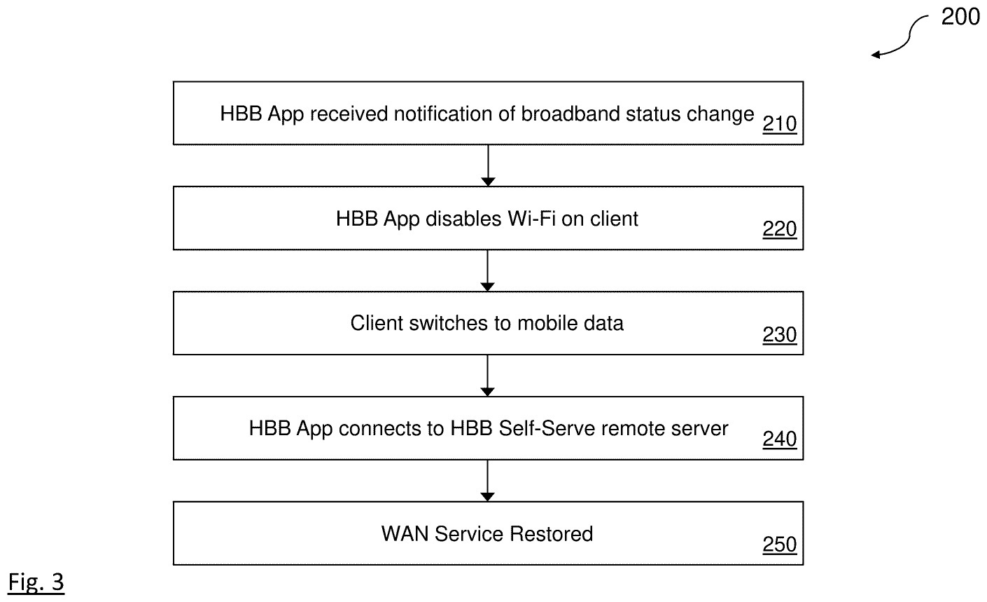

FIG. 3 shows a flowchart of a further method 200 that may take place following such a broadband status change or broadband outage. At step 210, the HBB app 50 of the client 40 receives notification of the broadband status change. This is provided by the subscribed service of the gateway 10 to the client 40. The HBB app 50 may be running in the background of the client 40.

At step 220, the HBB app 50 disconnects the Wi-Fi connection between the Wi-Fi interface 60 of the client 40 and the LAN interface 20 of the gateway 10. For example, this may be achieved by disabling the Wi-Fi interface 60 or by other means. The HBB app 50 may then cause the client 40 to restore internet connectivity over the cellular interface 70. Alternatively, the client 40 may detect the lack of Wi-Fi network availability and automatically switch to cellular connection via the cellular interface 70. In other words, the HBB app 50 may only disconnect Wi-Fi connectivity, or may both disconnect Wi-Fi connectivity and actively restore connectivity over an alternative network interface. Therefore, the client switches to mobile data connectivity at step 230.

Once internet connectivity of the client 40 is restored then the HBB app makes a connection with the HBB self-serve server 90 at step 240. This may be implemented by requesting user credentials from the user (e.g., at a prompt screen) or by using pre-stored credentials to automatically logon to the HBB self-serve server 90 by the HBB app 50. The HBB self-serve server 90 can then restore the broadband service (e.g., a DSL connection). This step is shown on FIG. 3 as step 250 (WAN service restored). This may be a manual process using input from the logged-on user or this step may be automated (if the remote server can achieve this without user input).

In another example implementation, the HBB app 50 may provide a hyperlink (URL), shortcut, or other link or pointer to the address of the HBB self-serve server 90, which the user may select or click on to initiate a connection with the HBB self-serve server 90. The HBB app may advantageously provide the HBB self-serve server 90 with details of the particular problem or symptoms of the broadband issue. This may be derived from the subscribed broadband status service. For example, the information that can be automatically provided may include data indicating a total loss of the DSL line connection, low data rates, high latency, persistent disconnections, or other issues. This avoids the need for the user to provide this manually (whether or not they are aware of the particular symptoms) when interacting with the HBB self-serve server 90.

In any case, the broadband connectivity between the gateway 10 and the internet may be restored at step 50 following actions instructed by the user or HBB app 50 to the HBB self-serve server 90. This may be automated or involve manual steps taken by the user of the client 40.

For example, the HBB self-serve server 90 may change settings on the gateway 10, reboot the gateway 10 or carry out checks and remedial action on equipment or services located at an exchange that is connected to the WAN interface 30 of the gateway 10. Therefore, broadband connectivity can be restored to the gateway 10 and ultimately to clients connected to the gateway 10.

There may be a plurality of clients 40 connected using the LAN interface 20 to the gateway 10. Any one or more of these may include the functionality described above and the HBB app 50. Other clients may not include such functionality but following the method 200, their internet connectivity may also be restored.

There may be more than one HBB self-serve server 90 in operation for load-balancing or other purposes.

The broadband status being broadcast by the gateway 10 may also change to indicate that broadband connectivity has been restored. Such a notification may also be provide to the HBB app 50.

In this way when a router or gateway goes down, a subscription status is sent to the phone or other device showing a notification of the outage. The user can either ignore the notification or choose to diagnose the issue. Choosing the diagnose option uses 4G to send the user straight to a self-diagnostic help page of an external service.

Additional functionality of the system may include providing a rapid diagnosis of the internet being down in specific areas across multiple locations (as all clients in that particular area will receive the outage notification). This also enables proactive monitoring of the ISP and may be based on which users have clicked through to the self-diagnostic page.

With proactive notification, quicker and more accurate data about services that are down may be provided, this could allow intelligent major outage notification and call deflection.

FIG. 1 includes numbered arrows indicating particular events that can take place in the system 5. Arrows 1 to 6 indicate the steps that can take place when the client 40 forms a Wi-Fi connection. Arrows 7-15 show the steps that take place when the WAN connection with the internet experiences a partial or total failure.

Arrow 1 indicates the client 40 (e.g., a smartphone) has started or booted up and is in communication with the Wi-Fi interface 60. A Wi-Fi network provided by the gateway 10 is available but not connected to the client 40 at this stage.

Arrow 2 indicates a request being made by the client 40 to the gateway 10 once the Wi-Fi connection is made. This is sent over the Wi-Fi connection and requests subscription using UPnP for the DSL (or other broadband) status of the gateway 10.

Arrow 3 illustrates the gateway receiving this subscription request and obtains the UPnP DSL Status property.

Arrow 4 shows the DSL status being passed back to the LAN (e.g., Wi-Fi) interface 20 in the gateway 10.

Arrow 5 shows the DSL status being passed over Wi-Fi to the client 40.

Arrow 6 shows the received DSL status being passed to the client 40 to the HBB App 50.

Arrow 7 indicates the fixed line (DSL or cable) being disconnected from the gateway 10 and indicating a broadband outage or other problem.

Number 8 in FIG. 1 indicates the UPnP DSL status property within the gateway 10 being updated and changing to a state of “Disconnected” (or other issue) in response to this broadband outage.

Arrow 9 shows the initiation of the UPnP notification of the DSL status change through the LAN interface 20.

Arrow 10 shows this notification being sent Wi-Fi to subscribed Wi-Fi devices, including the client 40.

Arrow 11 shows the client 40 receiving the DSL status change and passing this information to the HBB App 50.

Arrow 12 shows the HBB App 50 running business logic (e.g., wait time, delays, other checks, etc.) and disconnects the client 40 from Wi-Fi after the business logic has run. This functionality within the HBB App 50 can reduce the occurrence of unwanted notifications for short outages or issues that can be resolved quickly without requiring user intervention. The user may be able to change settings controlling the business logic (e.g., defining hours or times when notifications will not be issued or the HBB App 50 will not be initiated) or such settings may be fixed and common to all users.

Arrow 13 shows the HBB App 50 initiating a request to the HBB self-serve server 90 by presenting a URL to the user. The HBB App 50 may automatically launch the default browser of the client 40 and/or launch the particular URL in that default browser. Alternatively, the HBB App 50 may include its own browser.

Arrow 14 shows the client 40 using a cellular connection 70 (e.g., 4/5G) to send the request to the HBB self-serve server 90 using the URL. The HBB App 50 can guide the user through the interaction with the HBB self-serve server 90 or can take automated actions such as initiating remote testing of the DSL line, for example.

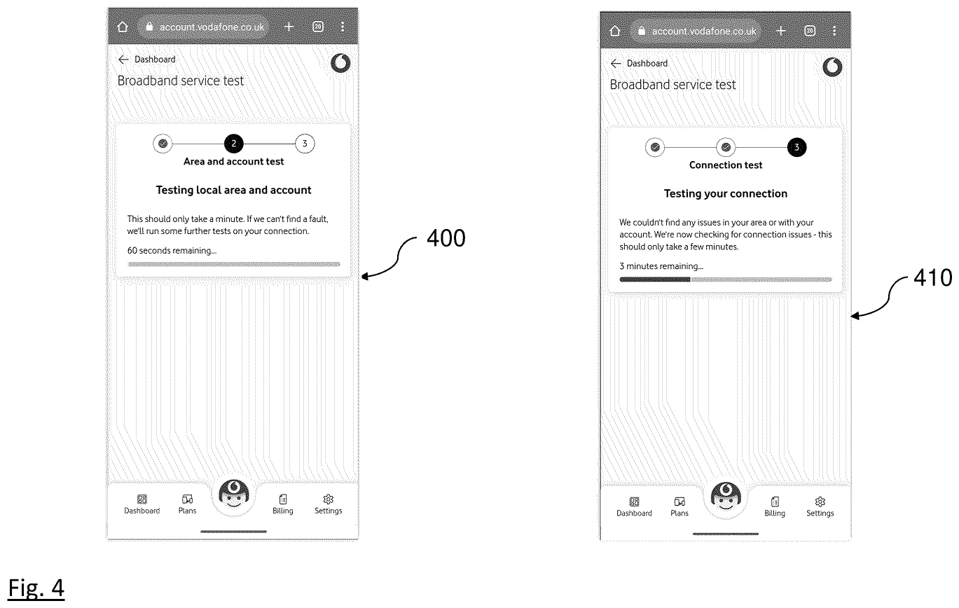

Automated actions taken by the HBB self-serve server 90 may include detecting a user account associated with the HBB App 50 that has made the request to the HBB self-serve server 90 (e.g., using username details transmitted by the HBB App 50 and included in the URL). Faults may be remedied by automatically initiating a diagnostics session with the HBB self-serve server 90. This may include account checks (to check the account is not blocked), a sync check (to check there is a line sync), and a session check (to check device logged in). These are completed without any further user interaction. Further steps may include any one or more of: identifying a broadband line associated with the user account, and/or a gateway 10 that was last connected to the broadband line, testing a local area of the line and/or account or account settings, testing the line for errors of faults, and/or testing the connection with the gateway 10 (e.g., latency, bandwidth, connectivity, etc.). For example, the account may be suspended, or closed, the broadband line may have active maintenance, the broadband line may have parameter errors, and/or hardware associated with the broadband line may require rebooting. FIG. 4 shows screenshots of the HBB App 40 taken when some or all of these automated actions are being carried out. These actions may also be initiated manually by the user, or the user may be asked within the HBB App 40 to confirm that these tests may be executed.

Number 15 indicates a HBB self-serve journey (i.e., further steps not detailed her) that rectifies the fault and restores broadband connectivity to the gateway 10.

As will be appreciated by the skilled person, details of the above embodiment may be varied without departing from the scope of the present invention, as defined by the appended claims.

For example, the DSL or cable broadband connection to an ISP may be replaced with another internet connection (e.g., a cellular connection). This could be different (i.e., on a different account or a different network provider) to the cellular connection used by the client device. The gateway may be a single unit or device including a modem and wireless router or may comprise separate parts. Where separate units are used then the modem may send the wireless router notification of a status change, or the wireless router may detect a lack of internet connectivity and change the published status. Multiple clients may subscribe to the broadband status and operate in a similar way.

Many combinations, modifications, or alterations to the features of the above embodiments will be readily apparent to the skilled person and are intended to form part of the invention. Any of the features described specifically relating to one embodiment or example may be used in any other embodiment by making the appropriate changes.

1. A method for managing a Wi-Fi network, the method comprising the steps of:
a Wi-Fi client subscribing to a broadband status of a gateway when the Wi-Fi client connects to the access point of the gateway;
the Wi-Fi client detecting a change in the subscribed broadband status indicating a disruption in broadband connectivity of the gateway; and
in response to the detected change of the subscribed broadband status generating a user notification on the Wi-Fi client.

2. The method of claim 1, wherein the Wi-Fi client subscribes to the broadband status using universal plug and play, UPnP, general event notification architecture, GENA.

3. The method of claim 1 further comprising the step of the Wi-Fi client passing the detected changed broadband status to an application of the Wi-Fi client.

4. The method of claim 3 further comprising the step of:
the application disconnecting the Wi-Fi client from the Wi-Fi network.

5. The method of claim 4 further comprising the step of the Wi-Fi client connecting to a cellular data network.

6. The method of claim 5 further comprising the step of the application:
logging on to an external server using user credentials of a user of the Wi-Fi client, wherein the external server includes broadband connectivity reinstatement functionality.

7. The method of claim 6, wherein the external server is accessed by the application of the Wi-Fi client using the cellular data network.

8. The method of claim 3 further comprising the step of the application:
presenting a user of the Wi-Fi client with a shortcut or hyperlink to an external server requesting assistance with broadband connectivity.

9. The method of claim 1 wherein the user notification is delayed by a predetermined time from the detection of the change of the subscribed broadband status.

10. The method of claim 9, wherein the predetermined time is user-configurable using an application of the Wi-Fi client.

11. The method of claim 1, wherein the change in the broadband status is any one or more of a total loss of broadband connectivity between the gateway and the internet or a reduction in broadband speed below a predetermined threshold.

12. A data processing apparatus comprising:
a processor;
a non-transitory computer readable storage medium having stored thereon computer executable instructions that, when executed by the processor, cause the date processing apparatus to perform the steps of:
a Wi-Fi client subscribing to a broadband status of a gateway when the Wi-Fi client connects to the access point of the gateway;
the Wi-Fi client detecting a change in the subscribed broadband status indicating a disruption in broadband connectivity of the gateway; and
in response to the detected change of the subscribed broadband status generating a user notification on the Wi-Fi client.

13. A system comprising:
a gateway having an access point and a broadband interface, the gateway configured to provide a subscription to a broadband status of the gateway;
one or more Wi-Fi clients, the Wi-Fi clients configured to:
subscribe to the broadband status of the gateway when the Wi-Fi client connects to the access point of the gateway,
detect a change in the broadband status indicating a disruption in broadband connectivity of the gateway, and
in response to the detected change of the subscribed broadband status generating a user notification on the Wi-Fi client.

14. The system of claim 13, wherein the gateway is configured to provide broadband connectivity using a digital subscriber line, DSL.

15. The system of claim 13 further comprising an external server configured to:
validate credentials of the Wi-Fi client, and
reinstate broadband connectivity of the gateway upon request from the Wi-Fi client.
